(19) United States
(12) Patent Application Publication
(10) Pub. No.: US 2024/0275863 A1
(43) Pub. Date: Aug. 15, 2024

(54) Opportunistic Migration of Data Between Cloud Storage Provider Systems

(71) Applicant: Attimis Corporation, Sunnyvale, CA (US)

(72) Inventors: Leon Rishniw, San Francisco, CA (US); Georgiy Yakovlev, Pacifica, CA (US); Domenico Guardini, San Jose, CA (US); Damian Kowalewski, Sunnyvale, CA (US)

(21) Appl. No.: 18/441,954

(22) Filed: Feb. 14, 2024

Related U.S. Application Data
(60) Provisional application No. 63/485,228, filed on Feb. 15, 2023.

(51) Int. Cl. H04L 67/568; H04L 67/1097

(52) U.S. Cl. CPC H04L 67/568; H04L 67/1097

(57) ABSTRACT

A protocol-agnostic proxy can be used between a cloud client and multiple networked data storage servers as might be operated by cloud service providers. The proxy can, transparent to a requesting client, opportunistically migrate data stored in a first networked data storage server to a second networked data storage server. This can be done as specific data is requested by the client. Data objects can be transparently, to the client, migrated to a second networked data storage server. The complexity of data object retrieval can be opaque to the requesting client. In addition to migrating to a second networked data storage server, the proxy might handle migration to a third and additional servers. The protocols used between various networked data storage services might vary from provider to provider, and even within services of one provider. In any case, the proxy can present a consistent view of data to clients.

### CROSS-REFERENCES TO PRIORITY AND RELATED APPLICATIONS

This application claims the priority benefit under 35 U.S.C. § 119(e) of U.S. Provisional Application No. 63/485,228, filed Feb. 15, 2023, hereby incorporated by reference in its entirety as though fully set forth herein.

### FIELD

The present disclosure generally relates to cloud storage and more particularly to migration of content among cloud storage provider systems in light of costs and constraint of cloud operations.

### BACKGROUND

Cloud data storage and remote processing are services provided by many cloud computing providers. Data storage can come in several forms, such as object storage, blob storage, structured data storage, etc. Typically, data is stored within a cloud server's system and that cloud server's system provides for particular provider-specific protocols to upload, manage, and retrieve content. Different providers of cloud services might have different, provider-protocols for object storage that are often not cross-compatible with other providers of cloud services.

Each cloud computing provider might charge for particular actions or resource use, such as one fee per unit of data that is uploaded to a provider server, another fee per unit of computation performed, yet another fee for storage per unit of data per unit of time, and fees for joining and/or leaving a cloud computing provider that might be per unit of data stored at a cloud computing provider's system.

In a common arrangement, some person, entity, organization, etc. operates client computer systems that rely on one or more cloud computing system to perform their expected functions. The client system operator might operate the client computer systems for their own benefit or interests, or might operation the client computer systems at the behest of others, such as their customers, employees, etc. In such an arrangement, the client system operator might install hardware, software, firmware, logic, network connections, etc. to implement a client computer system, which might be simply referred to as a client, operate the client and connect it to a network, such as the Internet, so that the client can interact with one or more cloud computing system or server. A cloud computing system, cloud data storage, or other cloud server might be implemented by a cloud computing service provider using hardware, software, firmware, logic, network connections, etc. to implement a cloud computing server that can provide one or more cloud computing service.

The cloud computing service provider might provide the service to many client system operators with pricing for the service determined by agreement and based on various usage quantities. A client computer system and a cloud server might interact by sending messages that conform to a particular protocol. The particular protocol might be a protocol developed and promulgated by the cloud computing service provider or might be an industry-standard protocol. The cloud server would then be programmed to understand interactions that use that protocol and/or include a communications module or component that is programmed for, or configured for, interacting consistent with that protocol. The particular protocol to be used with interaction with the cloud server can be communicated to the client system operator so that the client system operator can program or configure the client computer system to communicate consistent with that protocol or include a module or component to handle interactions consistent with that protocol.

A protocol might define what messages can be sent to a server or client and how the server or client is to respond. Some messages might be, for example, requests for data or computation and other messages might be status messages, reply messages possibly including data that was requested, etc. In some cases, a protocol might be implemented using an application programming interface (API). For example, a cloud computing service provider might create an API and associate code, and provide this to client system operators so that they can have their client computer system interact with the cloud computing service provider's cloud server in a consistent and expected manner. Where the client computer system is to interact with more than one cloud server operated by one or more cloud computing service provider, the client computer system might be programmed to interact using more than one protocol, with a particular protocol selected based on which cloud servers the client computer system is set up to interact with.

Using the appropriate and designated protocols, a client computer system might issue commands, consistent with a protocol, related to content and a provider's cloud, i.e., in cloud data service infrastructure that the provider owns, operates, and/or manages. Examples of commands might be commands related to uploading data, downloading data, modifying data, moving data, deleting data, performing computations on data, or other operations that can be performed by, or supported by, the cloud data service infrastructure.

A provider might maintain a billing computer system that tracks a client computer system's requests and compile billing records to bill the client system operator based on those requests according to some fee schedule that can be represented in computer memory. One such fee is an egress fee for leaving a cloud data service. More generally, a provider might impose various constraints on users of their cloud data services, such as data traffic-based charges, bandwidth capacity limits, latency constraints, throughput limits, and other constraints. As a client system operator's data storage needs grow over time, the costs associated with cloud data management and access typically increase. Additionally, business continuity becomes increasingly reliant on reliable data access.

Migrating from one cloud provider to another cloud provider involves constraints, in addition to possibly requiring changes to protocols. For example, migration might incur egress costs and other costs and/or constraints.

Improved methods and apparatus for migration among cloud providers are desirable.

### SUMMARY

A protocol-agnostic proxy can be used between a cloud client and multiple networked data storage servers as might be operated by cloud service providers. The proxy can, transparent to a requesting client, opportunistically migrate data stored in a first networked data storage server to a second networked data storage server. This can be done as specific data is requested by the client.

By inserting a proxy server between the requesting client and the first networked data storage server, no implementation changes need be required of the requesting client. The requesting client can continue to communicate with the proxy server as it communicates with the first networked data storage server.

When the client requests a first data object, the proxy server can determine if the requested first data object is available in the second networked data storage server. If it is, then the proxy server retrieves the first data object from the second networked data storage server. If the first data object is not available from the second networked data storage server, then the first data object is retrieved from the first networked data storage server. As the first data object is retrieved by the proxy server and returned to the client, the first data object can be replicated to the second networked data storage server. This allows subsequent client requests for the first data object to be retrieved from the second networked data storage server.

Data objects can be transparently, to the client, migrated to a second networked data storage server. In some embodiments, only the data objects that are currently being requested are migrated, thereby avoiding any additional migration costs. While this can result in fragmentation of data objects across servers of multiple networked data storage servers, the complexity of data object retrieval can be opaque to the requesting client.

In addition to migrating to a second networked data storage server, the proxy might handle migration to a third and additional servers. The protocols used between various networked data storage services might vary from provider to provider, and even within services of one provider. In any case, the proxy can present a consistent view of the data to the clients.

This Summary is provided to introduce a selection of concepts in a simplified form that are further described below in the Detailed Description. This Summary is not intended to identify key features or essential features of the claimed subject matter, nor is it intended to limit the scope of the claimed subject matter. A more extensive presentation of features, details, utilities, and advantages of methods and apparatus, as defined in the claims, is provided in the following written description of various embodiments of the disclosure and illustrated in the accompanying drawings.

### BRIEF DESCRIPTION OF THE DRAWINGS

Various embodiments in accordance with the present disclosure will be described with reference to the drawings, in which:

FIG. 1 is a block diagram of a client-proxy-server arrangement, according to various embodiments.

FIG. 2 is a block diagram of another client-proxy-server arrangement, according to various embodiments.

FIG. 3 is yet another block diagram of another client-proxy-server arrangement, according to various embodiments.

FIG. 4 illustrates an example computer system memory structure as might be used in performing methods described herein, according to various embodiments.

FIG. 5 is a block diagram illustrating an example computer system upon which the systems illustrated in FIGS. 1 and 4 may be implemented, according to various embodiments.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

In a typical implementation of network storage, a client system operator operates a client computer system that interacts as a client with a server computer system operated, owned, and/or maintained by a cloud service provider that interacts with the client as a server. Typically, many clients will be interacting with one or more servers, making requests and receiving responses from the servers. A network might exist to carry messages and data traffic between clients and servers. A client might be implemented by a computer, computer system, hardware, software, firmware, and/or some combination thereof. A server might be implemented by a computer, computer system, hardware, software, firmware, and/or some combination thereof.

Servers are said to implement one or more services. One such service is a networked data storage service wherein clients are remote from servers in that there is a network between them and wherein clients can make requests of one or more servers. Requests might include a request to store particular data at the server, modify data held or managed by the server, delete data held or managed by the server, return data held or managed by the server, etc. As such, the service is a networked data storage service. A networked data storage server might include some form of storage capability for data, which might vary from server to server and from time to time and might be opaque to clients. By pre-agreement, protocols and formats for client requests and server responses might be according to a specified protocol specific to a particular service. For example, the fields and formats of messages conveying a client request to store data might vary from service to service and the server's responses might vary from service to service. In a specific example, a client is expected to format a message that is a request to store data with a client identifier, followed by a size of the data object to be stored, parameters about the storage terms, and followed by the data object itself. The server might be expected, per the service's pre-agreed protocol, to respond with a confirmation message that includes an indication of success/failure of the request, a session identifier, a parameter indicating the cost to be billed for the storage (e.g., in units of currency per number of bytes per time period, such as dollars per gigabyte per day).

In a typical operation, a client might make a request to a server to store data specified in the request. The data might be included in the request or the request might include a link or reference to where a server can obtain the data to be stored. The server might respond with an acknowledgement of the storage request. The client might make a request for retrieval of data from the server and the server might respond with the requested data or a link or reference to where the client can obtain the requested data. Thus, data can flow in the client-to-server direction as well as the server-to-client direction.

A proxy can be a computer, computer device, software service, etc. that is operationally positioned between one or more client and one or more server. A proxy might be a proxy layer that is more involved than just a simple network node between a client and server. A proxy might be implemented by a computer, computer system, hardware, software, firmware, and/or some combination thereof. In a typical operation, a proxy layer is operationally between a client and a server such that the client interacts with the proxy as if the client were interacting with a server and the server interacts with the proxy as if the server were interacting with the client. Thus, the client would use the pre-agreed protocols to interact with the server but would actually be interacting with the proxy, while the server would use the pre-agreed protocols to interact with the client but would actually be interacting with the proxy. The proxy might be implemented as a distinct hardware device or might be software running on a virtual or shared host. The proxy might be transparent to the client and/or server and might emulate the protocols used between a client and a server, such as a server for a given networked data storage service and thus the client and the server would interact with the proxy as if the client and server were interacting directly, emulating the protocol conversations as needed.

A particular protocol for interaction might be used by a client for a data transfer that is an upload of data from the client to the server for the intended purpose of having that data stored in one or more networked data storage services, as a “write” operation. Another particular protocol for interaction might be used by a client for a data transfer that is a download of data from the server to the client, retrieving data stored in one or more networked data storage services, as a “read” operation.

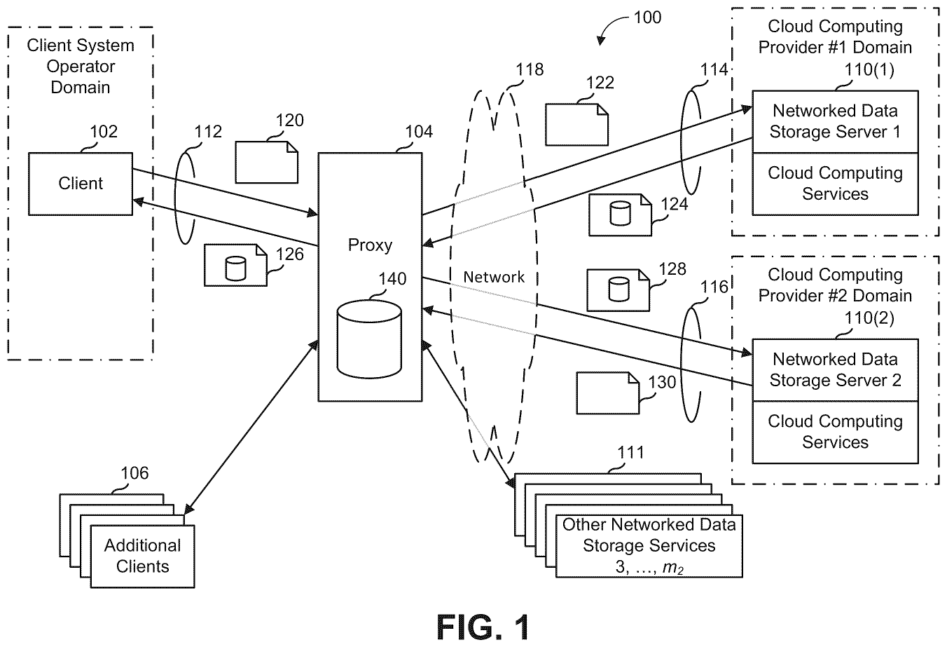

FIG. 1 illustrates an arrangement 100 of one or more client systems 102, 106 that interact with one or more network data storage servers 110, 111 through a proxy 104. As illustrated therein, client system 102 is within a client system operator's domain. As such, the client system operator might be paying for services from various networked data storage servers, which might be operated by a cloud computing provider. A cloud computing provider domain might also include cloud computing services, and possibly other services. As illustrated, data storage services might be provided by a networked data storage server 110(1) and/or a networked data storage server 110(2). Other networked data storage servers 111 might come into play as well.

Each cloud computing provider might charge for various activities and services, such as data storage per unit of data per unit of time, data inflow fees, data outflow fees, startup fees, egress fees, termination fees, etc. Networked data storage servers 110 might be accessed through a network 118 such as the Internet, an extranet, or other network arrangement.

In an example operation, client system 102 issues a message 120 toward networked data storage server 110(1). Message 120 is received by proxy 104 and is routed as message 122 toward networked data storage server 110(1). Messages 120 and 122 might be, for example, a request for a specific collection of data. Networked data storage server 110(1) might respond with a message 124 that contains data responsive to the request in message 122. Upon receipt, proxy 104 might forward that responsive data in a message 126 back to client system 102. In addition, proxy 104 might also send that data to networked data storage server 110(2) in message 128 and networked data storage server 110(2) might reply with message 103 to confirm receipt of message 128.

Each cloud computing provider might specify a protocol for messages to their servers and for responses to those messages. For example, cloud computing provider #1 might specify, and publish as needed, a protocol 114 to be used for messaging between a client and its servers. Cloud computing provider #2 might specify, and publish as needed, a protocol 116 to be used for messaging between a client and its servers and protocol 116 might be the same as protocol 114 or not. In some protocols, messages might be encrypted to be decoded by holders of private keys or other cryptographic details. A proxy might maintain keys and ciphers as needed to decrypt messages and data objects when received as encrypted messages and data objects an as needed to encrypt messages and data objects to send to a target networked data storage server and/or elsewhere. Where a source networked data storage server and a target networked data storage server use the same encryption protocols to encrypt the data and the data can be passed through the proxy as is, decryption and encryption might not be needed.

Proxy 104 might handle all the details of communicating with networked data storage server using their respective protocols. Client system 102 might communicate with proxy 104 using a protocol 112. In some cases, such as where protocol 112 is the same as protocol 114 and/or protocol 116, client system 102 might be communicating with a networked data storage server with proxy 104 being transparently interposed between client and server. Proxy 104 might manage communications such that client system 102 can communicate using protocol 112 and proxy 104 will transparently convert messages as needed to match a protocol of a networked data storage server and can transparently switch networked data storage servers. Each protocol might comprise a set of commands, instructions, message formats, message meanings, codes, and the like. A cloud computing provider might provide an API for client systems to use that implement the protocol. Such an API can run at a client system and/or at proxy 104. Messages might include details of requests, queries, data read/write/replace/modify commands, and the like. Some protocol-specific messages might include data, as illustrated in FIG. 1 by messages 124, 126, 128. An example of a protocol is Amazon's S3 protocol. Another example is Microsoft's Azure API protocols. Individual commands might be included in messages for requesting data, submitting data, asking for information about data stored by the server.

Proxy 104 might store data that is received from a client or server, stored into a local proxy storage 140. This data might be requested data, messages, unencrypted copies of encrypted data, etc. Proxy 104 might cache data for fulfilling future requests for that same data and might cache data until it can be provided to another networked data storage server. This might be used as part of an opportunistic migration process, wherein proxy 104 tracks client requests for data, retrieves that data from one networked data storage server, provides that data to the client in response to the client requests, but also conveys that data to a second networked data storage server.

Proxy 104 can maintain records of what data has been conveyed to the second networked data storage server. Such records could be used by proxy 104 to determine where to route a request from a client system. Proxy 104 can also send messages to query various servers to determine availability of certain data. Proxy 104 can thus migrate data from one networked data storage server to another without having to specifically egress the data for the purposes of migration. Migration might be initiated for cost reasons and/or for data redundancy reasons.

Proxy 104 can opportunistically migrate data objects from a first networked data storage server to a second networked data storage server. When client system 102 makes a download request for a first data object from networked data storage server 110(1), for example, the download request might be intercepted by proxy 104, which then can make a download request for the first data object to networked data storage server 110(1). When networked data storage server 110(1) returns that first data object to proxy 104, proxy 104 can returns the first data object to client system 102, while initiating an upload request to networked data storage server 110(2) for the first data object. In various embodiments, the upload request and the download data object can occur simultaneously, sequentially, or completely asynchronously.

Proxy 104 can cache replicated objects as needed. Proxy 104 might also store and/or cache pointers to replicated objects. For example, proxy 104 might maintain a service availability mapping for data objects it has handled.

In a first embodiment, network protocols 112, 114, 116 implemented between networked data storage service 110(1) and networked data storage service 110(2) are identical. This simplifies the implementation of proxy 104 in that there is no network protocol translation required to communicate with networked data storage service 110(2). Once the first data object has been successfully uploaded to the networked data storage service 110(2), subsequent download data transfers for the first data object can be retrieved from either networked data storage service 110(1) or networked data storage service 110(2). Proxy 104 can handle selection of which networked data storage service to utilize for subsequent download requests for the first data object.

When that first data object has been replicated to networked data storage service 110(2), proxy 104 may implement data source selection logic in several ways. A first example of data source selection logic may be the implementation of a Bloom filter, which provides rapid determination of the presence of the requested data transfer on each networked data storage service 110. In this first example, proxy 104 implements a stateful caching of data object locations on networked data storage services 110.

In a second example, proxy 104 performs a lazy query to networked data storage services 110 to determine whether the data object exists and where it exists. Protocols implemented by networked data storage services 110 can have specific commands for testing the presence of a data object. In the event that the protocol does not have a specific command for testing the presence of a data object, proxy 104 can perform a download data transfer request on the data object that can be aborted once the resulting status code has been returned, thereby utilizing the download status code as a determination of whether the data object exists on the particular networked data storage service.

Determining whether the requested first data object is available from the second networked data storage server might involve reading from a record of data object availability created by the proxy in response to prior requests. Determining whether the requested first data object is available from the second networked data storage server might involve performing a multi-stage check using a cache and executing a query.

In a third example, the customer may have configured preferential utilization of the available networked data storage servers, which can simplify logic required in proxy 104.

While these examples illustrate some of the logic that may be implemented in proxy 104, they should not be construed to limit the specific implementation; nor should they be considered mutually exclusive. In one embodiment of proxy 104, data source selection logic could implement all three logic examples in combination to accomplish the selection of which networked data storage service to utilize for the data transfer request.

As described herein, opportunistic replication from a first networked data storage service to a second networked data storage service might be done using a proxy. Additional services might also be supported. Multiple replication targets that may implement vastly different networking protocols.

A proxy might select a source networked data storage server from among a plurality of source networked data storage servers and select a target networked data storage server from among a plurality of target networked data storage servers. The selected target networked data storage server might be selected based on data security requirements. For example, the data security requirements might include jurisdictional data handling requirements, such as those imposed by the GDPR. Content migration can then be managed according to data security requirements. For example, if storing the data is inconsistent with the GDPR, a server not subject to the GDPR might be selected as the target networked data storage server whereas if the data needs to be stored consistent with the GDPR, a server that is GDPR-compliant might be selected as the target networked data storage server.

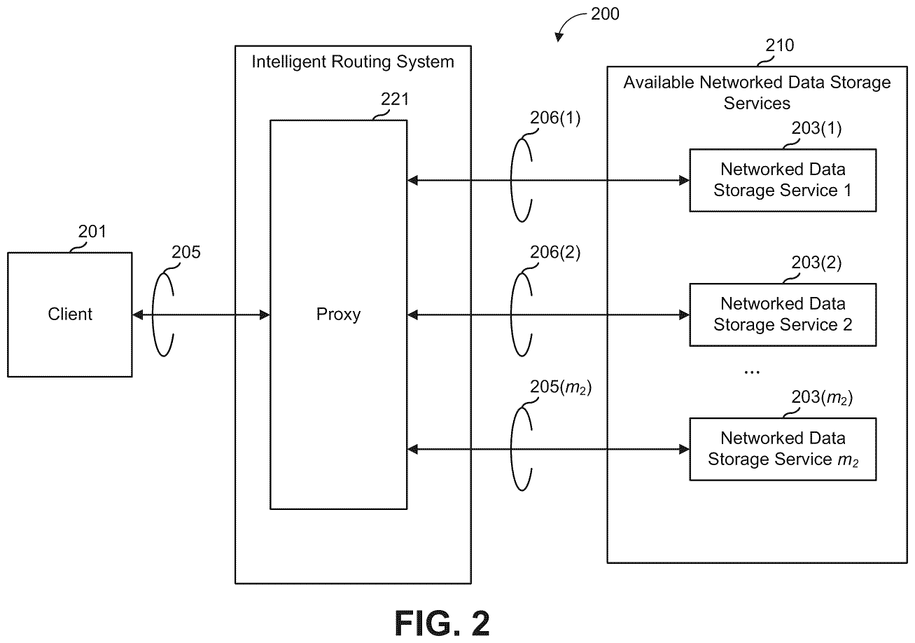

FIG. 2 illustrates the computing system 200 where a first networked data storage service 203(1) implements a different network protocol than a second networked data storage service 203(2). A client 201 implements a network protocol 205 that is common with a network protocol 206(1) that is implemented by the first networked data storage service 203(1). Client 201 can communicate directly with first networked data storage service 203(1) without needing intermediation by a proxy 221. A second networked data storage service 203(2) might not implement a networking protocol 206(2) that is not compatible with networking protocol 205. In this scenario, client 201 does not communicate directly with second networked data storage service 203(2), and proxy 221 provides a translation service between networking protocol 205 and networking protocol 206(2).

While networking protocol 205 and networking protocol 206(2) might provide an upload capability and a download capability, there is no requirement for compatible networking protocol commands, data size restrictions, or sequencing of data object parts. For the purposes of this scenario, consideration is given to the degenerate case where networking protocol 205 and networking protocol 206(2) are completely unrelated. In less degenerate scenarios, networking protocol 205 and networking protocol 206(2) can have similar commands, or derive from a common baseline protocol and proxy 221 can handle those cases as well.

To facilitate network protocol translation between networking protocol 205 and networking protocol 206(2), proxy 221 might be resilient to the differences between the networking protocols. One example of such a difference between protocols is support of multipart uploads. A multipart upload allows a client to chunk a first data object into several parts and send them independently to first networked data storage service 203(1). When all the data parts have been received by first networked data storage service 203(1) it stores the data parts such that it can identically reconstruct the first data object. While one networking protocol may support multipart uploads, there is no requirement for all networking protocols to support this functionality.

Consider a first scenario, where networking protocol 206(2) does not support multipart uploads; however, client 201 is utilizing this feature of networking protocol 205. In this scenario, proxy 221 caches each data part that is sent from the client and reconstructs the first data object prior to initiating an upload to second networked data storage service 203(2) using networking protocol 206(2). While this example of multipart uploads provides a clear distinction between the networking protocol 205 and networking protocol 206(2) to be accommodated by proxy 221, there are other considerations that may need to be supported by proxy 221. Similarly, this is not limited to the upload capabilities of the networking protocols, and applies to download capabilities and those required to facilitate data migration between networked data storage services.

Consider a second scenario, where networking protocol 205 is a more recent implementation of networking protocol 206(2). Additional capabilities may have been added to the more recent implementation of networking protocol 201 while networking protocols 205 and 206(2) might have been derived from the same common protocol. Consider further, that one of the differences between the newer implementation of networking protocol 205 is an enhancement of cryptographic security capability to include new cipher types and key lengths. This is a common extension in the current state of the art of network protocol implementations.

In this second scenario, proxy 221 should be able to decipher the newer cryptographic extensions facilitated in networking protocol 205 and then apply the cryptographic security that is compatible with the earlier networking protocol 206(2). In the event that proxy 221 does not provide sufficient capability for this translation, the first data object will not be replicated to the second networked data storage server 203(2).

Each of these scenarios address the two common variations in networking protocols, firstly, the protocol commands themselves, and secondly, the data payloads that are sent with each protocol command. Proxy 221 is not required to implement the full set of protocol capabilities, only those capabilities required to facilitate the opportunistic replication of the first data object.

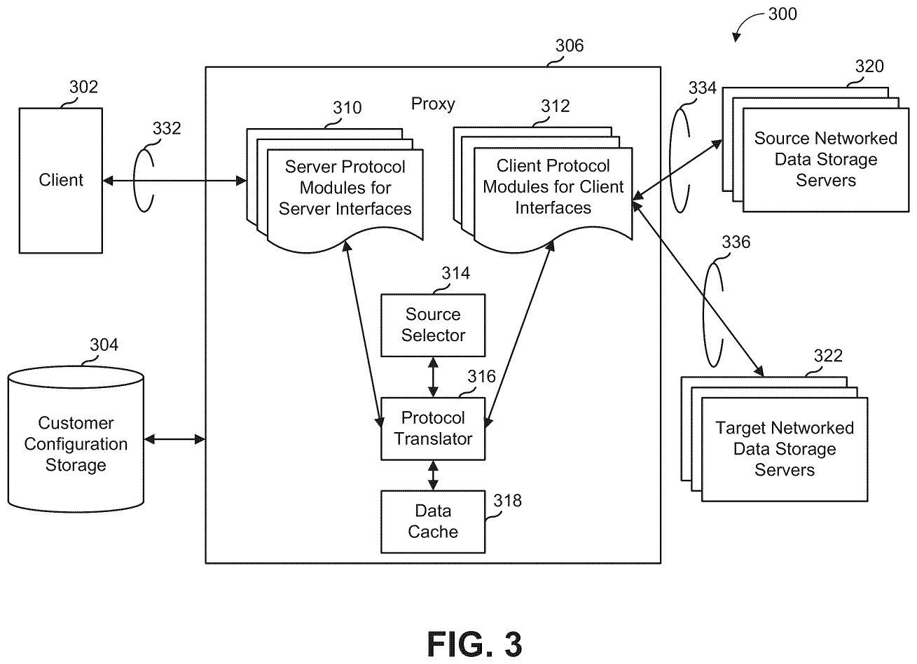

FIG. 3 illustrates an arrangement 300 of a client 302, a customer configuration storage 304, a proxy 306, as might be used to perform their respective functions and interact with source networked data storage servers 320 and target networked data storage servers 322. In a typical arrangement, there might be multiple clients and customer configurations operating with a proxy.

As illustrated there, proxy 306 might interact with customer configuration storage 304 to obtain information on the various networked data storage services 320, 222 that might be provisioned for the operator of client 302. In a replication or migration process, customer data might move from one or more of source networked data storage servers 320 to one or more of target networked data storage servicers 322. Additional information, specific to each networked data storage service 320, 322 might be stored in customer configuration storage 304. This includes, but is not limited to, authentication credentials to use with each networked data storage server 320, 322, source data configuration information for each replication source of source networked data storage server 320, target data configuration information for each replication target of target networked data storage servers 322, replication resiliency preferences, and subsequent data download preferences, and the like.

Proxy 306 might contain multiple server-side implementations of networking protocols, each of which might be implemented as server protocol modules 310. Proxy 306 might have one server protocol module for each unique protocol set used by the networked data storage servers. Proxy 306 can select an appropriate server protocol implementation that is compatible with a client-side protocol 332 implemented by client 302. The networking protocol implementation can be used for communication between client 302 and proxy 306. Proxy 306 can, as illustrated, contain multiple server-side implementations of networking protocols. Proxy 306 can use a source selector 314 to select among services provided by source networked data storage servers 320. Proxy 306 can select an appropriate client protocol implementation to use.

Proxy 306 might contain multiple client-side implementations of networking protocols, each of which might be implemented as client protocol modules 312. Proxy 306 might have one client protocol module for each unique protocol set used by clients that access proxy 306, which might be multiple protocol sets for a client if that client is expecting to interact with networked storage servers that use different protocols. Proxy 306 can select an appropriate client protocol implementation that is compatible with a server-side protocol 334, 336 implemented by the server/service that client 302 is attempting to interact with.

Proxy 306 can determine if there is a replication target among target networked data storage servers 322 by determining if a first data object has already been replicated to a specific target networked data storage server. If the first data object has been replicated to all configured target networked data storage servers 322, then proxy 206 might return the first data object to client 302.

Upon establishing the networking protocols to be utilized in the opportunistic data replication, proxy 306 can establish required protocol translation configurations using a protocol translator 316. Protocol translator 311 might determine required utilization of a data cache 318 based on the protocol translation configuration. Protocol translator 316 might also establish retry and fallback configurations based on data replication resiliency preferences.

When a data transfer configuration has been completed, protocol translator 316 can enable a selected server protocol implementation among server protocol modules 310 to respond to a data transfer request from client 302.

In one embodiment, client 302 sends a download request for a first data object to the selected server protocol module. Proxy 306 can then use source selector 314 to choose a source networked data storage server from the available set of source networked data storage servers 320 that host the first data object. Proxy 306 then transforms the request into a request consistent with the selected client protocol implementation of the selected client protocol module and sent to the selected source networked data storage server. The source networked data storage server can respond to the request from proxy 306 by transferring the first data object to proxy 306. Proxy 306 can then store the first data object in data cache 318 and invoke protocol translator 316 to send the first data object to client 302. Additionally, protocol translator 316 can establish an upload data transfer with each target networked data storage server 322. The data upload to each target networked data storage service can operate independently with proxy translator 316 managing coordination of all data transfers. Once all the data transfers have completed, the first data object can be flushed from data cache 318.

One example of opportunistic replication involves the requested first data object being stored on multiple source networked data storage servers. A new networked data storage service might be added and the addition indicated in the customer configuration with no data objects stored on it. When the first data object download request is made by client 302, proxy 306 determines which of the multiple source networked data storage services to use for servicing the first data object download request. Source selector 314 can provide this functionality by implementing the selection logic. The selection logic determines which networked data storage services host the first data object and are available to service the request. A selection logic implementation might involve stateful management of the data object stored in each of the available networked data storage services by utilizing a Bloom filter or a database. A stateless implementation could also be utilized where each available networked data storage service 320 is queried by proxy 306 to determine whether that particular service can service the first data object download request. Another implementation of the source selection logic could include a prioritized queue of available networked data storage services. A further implementation could combine several of these singular implementations based on specific requirements.

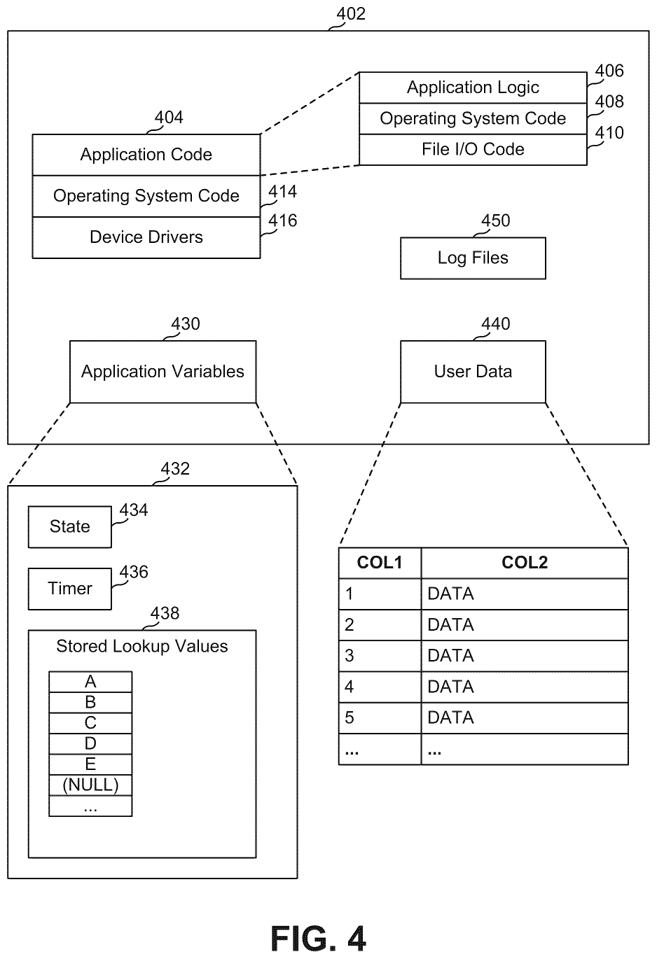

FIG. 4 is a simplified functional block diagram of a storage device 448 having an application that can be accessed and executed by a processor in a computer system as might be part of embodiments of a data migration system or method and/or a computer system that handles data migration among cloud service providers using a proxy. FIG. 4 might depict elements of a proxy and/or of other computational units described herein.

FIG. 4 also illustrates an example of memory elements that might be used by a processor to implement elements of the embodiments described herein. In some embodiments, the data structures are used by various components and tools, some of which are described in more detail herein. The data structures and program code used to operate on the data structures may be provided and/or carried by a transitory computer readable medium, e.g., a transmission medium such as in the form of a signal transmitted over a network. For example, where a functional block is referenced, it might be implemented as program code stored in memory. The application can be one or more of the applications described herein, running on servers, clients or other platforms or devices and might represent memory of one of the clients and/or servers illustrated elsewhere.

Storage device 448 can be one or more memory device that can be accessed by a processor and storage device 448 can have stored thereon application code 450 that can be configured to store one or more processor readable instructions, in the form of write-only memory and/or writable memory. The application code 450 can include application logic 452, library functions 454, and file I/O functions 456 associated with the application. The memory elements of FIG. 4 might be used for a server or computer that interfaces with a user and/or computer system, generates data, and/or manages other aspects of a process described herein.

Storage device 448 can also include application variables 462 that can include one or more storage locations configured to receive input variables 464. The application variables 462 can include variables that are generated by the application or otherwise local to the application. The application variables 462 can be generated, for example, from data retrieved from an external source, such as a user or an external device or application. The processor can execute the application code 450 to generate the application variables 462 provided to storage device 448. Application variables 462 might include operational details needed to perform the functions described herein.

Storage device 448 can include storage for databases and other data described herein. One or more memory locations can be configured to store device data 466. Device data 466 can include data that is sourced by an external source, such as a user or an external device. Device data 466 can include, for example, records being passed between servers prior to being transmitted or after being received. Other data 468 might also be supplied.

Storage device 448 can also include a log file 480 having one or more storage locations 484 configured to store results of the application or inputs provided to the application. For example, the log file 480 can be configured to store a history of actions, alerts, error message and the like.

According to some embodiments, the techniques described herein are implemented by one or more generalized computing systems programmed to perform the techniques pursuant to program instructions in firmware, memory, other storage, or a combination. Special-purpose computing devices may be used, such as desktop computer systems, portable computer systems, handheld devices, networking devices or any other device that incorporates hard-wired and/or program logic to implement the techniques.

One embodiment might include a carrier medium carrying data that includes data having been processed by the methods described herein. The carrier medium can comprise any medium suitable for carrying the data, including a storage medium, e.g., solid-state memory, an optical disk or a magnetic disk, or a transient medium, e.g., a signal carrying the data such as a signal transmitted over a network, a digital signal, a radio frequency signal, an acoustic signal, an optical signal or an electrical signal.

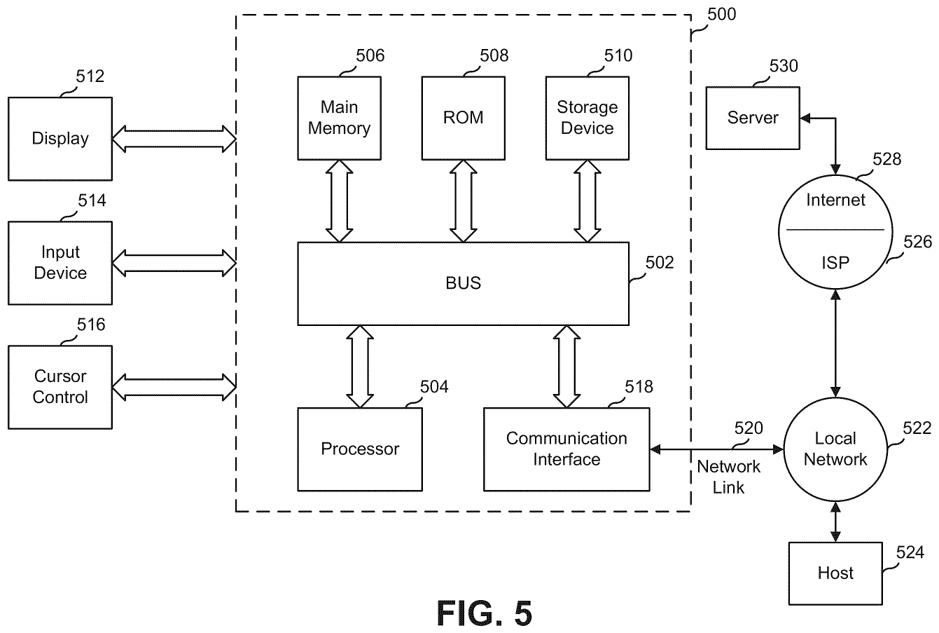

FIG. 5 is a block diagram that illustrates a computer system 500 upon which the computer systems of the systems described herein and/or data structures shown in FIG. 4 may be implemented. Computer system 500 includes a bus 502 or other communication mechanism for communicating information, and a processor 504 coupled with bus 502 for processing information. Processor 504 may be, for example, a general-purpose microprocessor.

Computer system 500 also includes a main memory 506, such as a random-access memory (RAM) or other dynamic storage device, coupled to bus 502 for storing information and instructions to be executed by processor 504. Main memory 506 may also be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

Computer system 500 may be coupled via bus 502 to a display 512, such as a computer monitor, for displaying information to a computer user. An input device 514, including alphanumeric and other keys, is coupled to bus 502 for communicating information and command selections to processor 504. Another type of user input device is a cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may include non-volatile media and/or volatile media. Non-volatile media includes, for example, optical or magnetic disks, such as storage device 510. Volatile media includes dynamic memory, such as main memory 506. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, an EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire, and fiber optics, including the wires that include bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid-state drive of a remote computer. The remote computer can load the instructions into its dynamic memory and send the instructions over a network connection. A modem or network interface local to computer system 500 can receive the data. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be a network card, a modem, a cable modem, or a satellite modem to provide a data communication connection to a corresponding type of telephone line or communications line. Wireless links may also be implemented. In any such implementation, communication interface 518 sends and receives electrical, electromagnetic, or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world-wide packet data communication network now commonly referred to as the “Internet” 528. Local network 522 and Internet 528 both use electrical, electromagnetic, or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520, and communication interface 518. In the Internet example, a server 530 might transmit a requested code for an application program through the Internet 528, ISP 526, local network 522, and communication interface 518. The received code may be executed by processor 504 as it is received, and/or stored in storage device 510, or other non-volatile storage for later execution.

Operations of processes described herein can be performed in any suitable order unless otherwise indicated herein or otherwise clearly contradicted by context. Processes described herein (or variations and/or combinations thereof) may be performed under the control of one or more computer systems configured with executable instructions and may be implemented as code (e.g., executable instructions, one or more computer programs or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory. The code may also be provided carried by a transitory computer readable medium e.g., a transmission medium such as in the form of a signal transmitted over a network.

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., may be either A or B or C, or any nonempty subset of the set of A and B and C. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present.

The use of examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

Further embodiments can be envisioned to one of ordinary skill in the art after reading this disclosure. In other embodiments, combinations or sub-combinations of the above-disclosed invention can be advantageously made. The example arrangements of components are shown for purposes of illustration and combinations, additions, re-arrangements, and the like are contemplated in alternative embodiments of the present invention. Thus, while the invention has been described with respect to exemplary embodiments, one skilled in the art will recognize that numerous modifications are possible.

For example, the processes described herein may be implemented using hardware components, software components, and/or any combination thereof. The specification and drawings are, accordingly, to be regarded in an illustrative rather than a restrictive sense. It will, however, be evident that various modifications and changes may be made thereunto without departing from the broader spirit and scope of the invention as set forth in the claims and that the invention is intended to cover all modifications and equivalents within the scope of the following claims.

All references, including publications, patent applications, and patents, cited herein are hereby incorporated by reference to the same extent as if each reference were individually and specifically indicated to be incorporated by reference and were set forth in its entirety herein.

What is claimed is:

1. A method of data processing using a proxy, the method comprising:
receiving, from a client device, a first data object request requesting a first data object, wherein the first data object request is directed by the client device to a first networked data storage server;
determining, using the proxy, whether the requested first data object is available from a second networked data storage server;
if the requested first data object is available from the second networked data storage server, retrieving the requested first data object from the second networked data storage server using the proxy;
if the requested first data object is not available from the second networked data storage server, retrieving the requested first data object from the first networked data storage server using the proxy;
providing the requested first data object to the client device; and
if the requested first data object is not available from the second networked data storage server, providing the requested first data object, using the proxy, to the second networked data storage server.

2. The method of claim 1, wherein determining whether the requested first data object is available from the second networked data storage server comprises executing an asynchronous query.

3. The method of claim 1, wherein determining whether the requested first data object is available from the second networked data storage server comprises reading from a record of data object availability created by the proxy in response to prior requests.

4. The method of claim 1, wherein determining whether the requested first data object is available from the second networked data storage server comprises:
performing a multi-stage check using a cache; and
executing a query.

5. The method of claim 1, wherein the first data object request is received according to a first protocol, retrieving the first data object from the second networked data storage server is performed according to a second protocol, and retrieving the requested first data object from the first networked data storage server is performed according to a third protocol.

6. The method of claim 5, further comprising:
caching a multipart request from the client device if the first protocol provides for multipart request and the second protocol and/or the third protocol does not; and
assembling a plurality of data parts from the multipart request into a single request to form a combined request; and
providing the combined request to the second networked data storage server and/or the first networked data storage server.

7. The method of claim 1, further comprising:
caching the requested first data object at the proxy as a cached copy; and
providing the cached copy to the second networked data storage server as the requested first data object.

8. A method of data migration from a source networked data storage server to a target networked data storage server, the method comprising:
determining, using a proxy, a first protocol for interacting with the source networked data storage server;
determining, using the proxy, a second protocol for interacting with the target networked data storage server;
receiving, from a client device using the first protocol, a first data object request requesting a first data object, wherein the first data object request is directed by the client device to the source networked data storage server;
obtaining the first data object from the source networked data storage server, using the first protocol;
providing the first data object to the client device, using the first protocol; and
providing the first data object to the target networked data storage server, using the second protocol.

9. The method of claim 8, further comprising caching the first data object at the proxy after obtaining the first data object from the source networked data storage server and before providing the first data object to the target networked data storage server.

10. The method of claim 8, further comprising interacting with a plurality of source networked data storage servers to obtain client data.

11. The method of claim 8, further comprising interacting with a plurality of target networked data storage servers to migrate client data to.

12. The method of claim 8, wherein the first protocol and the second protocol are the same protocol.

13. The method of claim 8, wherein the first protocol comprises first encryption steps, the second protocol comprises second encryption steps, and the first encryption steps are distinct from the second encryption steps, the method further comprising:
using the first encryption steps to decrypt the first data object as received from the source networked data storage server; and
using the second encryption steps to encrypt the first data object prior to sending to the target networked data storage server.

14. The method of claim 8, further comprising:
selecting the source networked data storage server from among a plurality of source networked data storage servers; and
selecting the target networked data storage server from among a plurality of target networked data storage servers, wherein a selected target networked data storage server is selected based on data security requirements.

15. The method of claim 14, wherein the data security requirements include jurisdictional data handling requirements.

16. A non-transitory computer-readable storage medium storing instructions, which when executed by at least one processor of a computer system, causes the computer system to migrate data as described herein.
